(19) United States
(12) Patent Application Publication
(10) Pub. No.: US 2009/0190067 A1
(43) Pub. Date: Jul. 30, 2009

(54) LIGHT DIFFUSER PLATE, SURFACE LIGHT SOURCE, AND LIQUID CRYSTAL DISPLAY

(75) Inventors: Toyohiro HAMAMATSU, Niihama-shi (JP); Takashi SAKAMOTO, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/357,430

(22) Filed: Jan. 22, 2009

(30) Foreign Application Priority Data
Jan. 30, 2008 (JP) 2008-019180

(51) Int. Cl. G02F 1/1335; G02B 5/02

(52) U.S. Cl. 349/64; 359/599

(57) ABSTRACT

An object of the present invention is to provide a light diffuser plate sufficiently suppressed in its yellowish coloring or the like and excellent in impact resistance.

The present invention relates to a light diffuser plate comprises a base layer which contains a styrenic resin and light diffuser particles, and a surface layer which contains a polycarbonate resin and which is laminated on at least one surface of the base layer. As the styrenic resin, a styrenic monomer-methacrylic acid copolymer resin is preferably used.

### BACKGROUND OF THE INVENTION

1. Field of the Invention

The present patent application claims priority under the Paris Convention based on Japanese Patent Application No. 2008-19180 (filed on Jan. 30, 2008), and the entire content of the aforementioned application is herein incorporated by reference.

The present invention relates to a light diffuser plate sufficiently suppressed in yellowish coloring thereof and excellent in impact resistance, and a surface light source and a liquid crystal display, each comprising this light diffuser plate.

2. Description of the Related Art

There are publicly known, for example, liquid crystal displays each of which has a surface light source as a backlight disposed on the rear side of a liquid crystal panel (or an image displaying member) including a liquid crystal cell. As the surface light source as the backlight, there is known a surface light source which comprises a plurality of light sources disposed in a lamp box (or a casing) and a light diffuser plate disposed on the front side of these light sources.

The light diffuser plate is required to have excellent impact resistance so as not to be damaged during transport thereof or assembling with use thereof accompanied by contact impacts. There is known a light diffuser plate satisfying such a requirement, which comprises an intermediate layer containing light diffuser particles in a styrenic resin, and surface layers laminated on both surfaces of the intermediate layer, wherein each surface layer contains crosslinked resin particles in a methyl methacrylate-butadiene-styrene copolymer resin (cf. JP-A-2007-199502/2007).

### SUMMARY OF THE INVENTION

However, this conventional light diffuser plate has a problem in its slight yellowish color tone as a whole, since the methyl methacrylate-butadiene-styrene copolymer resin forming the surface layers has a yellowish color.

This conventional light diffuser plate is also required to be further improved in impact resistance, in spite of its sufficient impact resistance, from the view point of surely protecting itself from damages due to contact impacts during the transport thereof or assembling with use thereof.

The present invention has been developed under such a technical background, and objects of the invention are therefore to provide a light diffuser plate sufficiently suppressed in yellowish coloring thereof and excellent in impact resistance, and a surface light source and a liquid crystal display, each comprising the same light diffuser plate.

The present invention provides the following means for achieving the above-described objects.

[1] A light diffuser plate, characterized in that a surface layer containing a polycarbonate resin is laminated on at least one surface of a base layer containing a styrenic resin and light diffuser particles.

[2] The light diffuser plate of the above item 1, wherein the styrenic resin is a styrenic monomer-methacrylic acid copolymer resin.

[3] The light diffuser plate of the above item 1 or 2, wherein a ratio of the thickness of the base layer to the thickness of the surface layer is from 5 to 100.

[4] A surface light source comprising a light diffuser plate defined in any one of the above items 1 to 3, and a plurality of light sources disposed on the rear side of the light diffuser plate.

[5] A liquid crystal display comprising a light diffuser plate defined in any one of the above items 1 to 3, a plurality of light sources disposed on the rear side of the light diffuser plate, and a liquid crystal panel disposed on the front side of the light diffuser plate.

In the invention of the item [1], the base layer is formed of a resin composition comprising the light diffuser particles in the styrenic resin, and thus has a light-diffusing function. This light diffuser plate is also excellent in impact resistance, since the surface layer containing the polycarbonate resin is laminated on at least one surface of the base layer. Accordingly, the light diffuser plate is not damaged, even when the light diffuser plate contacts other component, etc. during the assembling of, for example, a surface light source or a liquid crystal display, using this light diffuser plate. Further, yellowish coloring of the light diffuser plate is sufficiently suppressed, since the polycarbonate resin is hardly colored yellow or the like.

In the invention of the item [2], as the styrenic resin forming the base layer, the styrenic monomer-methacrylic acid copolymer resin is used. Therefore, the resultant light diffuser plate is excellent in heat resistance. In a surface light source or a liquid crystal display comprising this light diffuser plate, possibility of deformation of the light diffuser plate due to heat resulting from lightening of the light sources (e.g., cold cathode ray tubes, etc.) is extremely low, even when the light diffuser plate is included in a large apparatus with a screen size of model 32 or more in which the internal temperature becomes higher.

In the invention of the item [3], the light diffuser plate can ensure sufficient impact resistance while achieving cost reduction, since the ratio of the thickness of the base layer to the thickness of the surface layer is set at from 5 to 100.

In the invention of the item [4], the surface light source can have high quality, since the yellowish coloring of the light diffuser plate is slight, and since the light diffuser plate has excellent impact resistance.

In the invention of the item [5], the liquid crystal display can have high quality and high picture quality, since the yellowish coloring of the light diffuser plate is slight, and since the light diffuser plate has excellent impact resistance.

### BRIEF DESCRIPTION OF THE DRAWINGS

FIG. 1 is a schematic diagram illustrating an embodiment of a liquid crystal display according to the present invention.

FIG. 2 is a sectional view of an embodiment of a light diffuser plate according to the present invention.

### DESCRIPTION OF REFERENCE NUMERALS

1=a surface light source
2=a light source
3=a light diffuser plate
8=a base layer
9=a surface layer
20=a liquid crystal panel
30=a liquid crystal display
S=the thickness of the base layer
T=the thickness of the surface layer

### DETAILED DESCRIPTION OF THE PREFERRED EMBODIMENTS

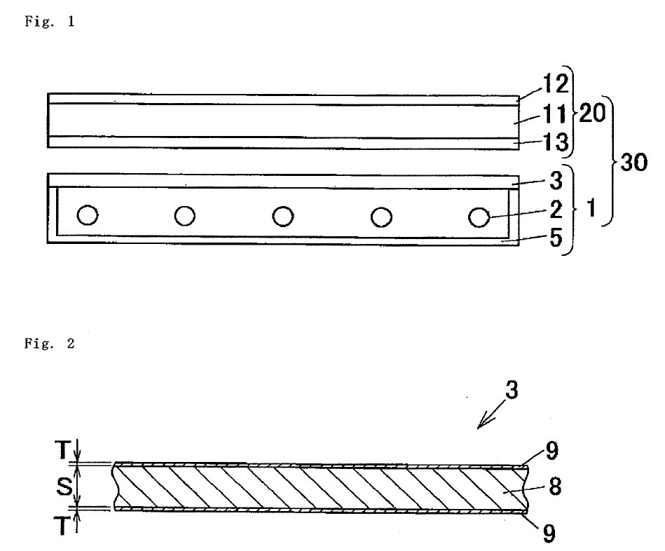

An embodiment of a liquid crystal display according to the present invention is shown in FIG. 1, wherein numeral (30) refers to a liquid crystal display; (11), to a liquid crystal cell; (12) and (13), to polarizing plates; and (1), to a surface light source (or a backlight). The polarizing plates (12) and (13) are disposed on both the upper and lower sides of the liquid crystal cell (11), and these components (11), (12) and (13) constitute a liquid crystal panel (20) as an image-displaying member. As this liquid crystal cell (11), such a liquid crystal cell that can display a colored image is preferably used.

The surface light source (1) is disposed under the lower side (or the rear side) of the lower polarizing plate (13) of the liquid crystal panel (20). That is, this liquid crystal display (30) is of direct type.

The surface light source (1) comprises a lamp box (5) in the shape of a slim casing which is rectangular in plan view and which is opened at its upper side (or front side), a plurality of linear light sources (2) spaced from one another in the lamp box (5), and a light diffuser plate (3) disposed on the upper side (or front side) of the plurality of linear light sources (2). The light diffuser plate (3) is so fixed to the lamp box (5) as to close the opening of the lamp box (5). The lamp box (5) is lined at its interior with a light-reflecting layer (not shown). While the light sources (2) are not limited, for example, cold cathode ray tubes, light-emitting diodes (or LEDs) are used.

As shown in FIG. 2, the light diffuser plate (3) comprises a base layer (8), and surface layers (9) and (9) laminated on and integrated into both surfaces of the base layer (8). The base layer (8) is formed of a resin composition containing a styrenic resin and light diffuser particles; and the surface layer (9) contains a polycarbonate resin.

The light diffuser plate (3) with this structure has a light-diffusing function because of the base layer (8) formed of the resin composition in which the light diffuser particles are dispersed in the styrenic resin. Since the surface layers (9) each containing the polycarbonate resin are laminated on both surfaces of the base layer (8), the light diffuser plate (3) has excellent impact resistance. Therefore, this light diffuser plate (3) is not damaged, even if it contacts other component, etc., during the assembling of a surface light source (3) or a liquid crystal display (30) using this light diffuser plate (3). Since the yellowish coloring or the like of the polycarbonate resin constituting the surface layers (9) is slight, the light diffuser plate (3) is sufficiently suppressed in its yellowish coloring or the like.

In the present invention, preferably, the base layer (8) is formed of the resin composition which comprises 0.1 to 10 parts by mass of the light diffuser particles per 100 parts by mass of the styrenic resin. When the amount of the light diffuser particles is 0.1 part by mass or more, a sufficient light-diffusing function can be imparted to the light diffuser plate. When the amount of the light diffuser particles is 10 part by mass or less, a sufficient mechanical strength can be ensured. Particularly preferable is the base layer (8) formed of the resin composition which contains 0.2 to 3 parts by mass of the light diffuser particles per 100 parts by mass of the styrenic resin.

The styrenic resin constituting the base layer (8) is not limited. Examples thereof include styrenic monomer-methacrylic acid copolymer resins, styrenic monomer-methyl methacrylate copolymer resins, styrenic monomer-maleic anhydride copolymer resins, polystyrene, etc. The use of the styrenic monomer-methacrylic acid copolymer resins is particularly preferable. In this case, the heat resistance of the light diffuser plate can be improved, so that deformation of the light diffuser plate (3) due to heat resulting from lightening of the light sources (cold cathode ray tubes, etc.) (2) can be effectively prevented.

The styrenic monomer-methacrylic acid copolymer is a copolymer of a styrenic monomer and methacrylic acid, wherein the styrenic monomer unit content is usually from 80 to 95% by mol, preferably from 88 to 93% by mol, and the methacrylic acid unit content, usually from 20 to 5% by mol, preferably from 12 to 7% by mol.

As the styrenic monomer, substituted styrene other than styrene may be used. Examples of the substituted styrene include halogenated styrenes such as chlorostyrene and bromostyrene, alkylstyrenes such as vinyl toluene and α-methylstyrene, etc. Each of these styrenic monomers may be used alone, or two or more selected therefrom may be used in combination.

The styrenic monomer-methacrylic acid copolymer may contain a monomer unit in addition to the styrenic monomer and the methacrylic acid. Examples of monomers constituting other monomer unit include methacrylates such as methyl methacrylate, ethyl methacylate, butyl methacrylate, cyclohexyl methacrylate, octadecyl methacrylate, phenyl methacrylate, benzyl methacrylate, octadecyl methacrylate, 2-ethylhexyl methacrylate, 2-hydroxyethyl methacrylate, adamantyl methacrylate, tricyclodecyl methacrylate, fencyl methacrylate, norbornyl methacrylate, norbornylmethyl methacrylate, etc.; acrylates such as methyl acrylate, ethyl acrylate, butyl acrylate, cyclohexyl acrylate, phenyl acrylate, benzyl acrylate, 2-ethylhexyl acrylate, 2-hydroxyethyl acrylate, tricyclodecyl acrylate, etc.; unsaturated acids such as acrylic acid, etc.; acrylonitrile; methacrylonitrile; maleic anhydride; phenyl maleimide; cyclohexyl maleimide; glutaric anhydride; glutarimide; and the like. Each of these monomers may be used alone, or two or more selected therefrom may be used in combination.

The light diffuser particles contained in the base layer (8) are not limited, in so far as they are particles which have a refractive index different from that of the styrenic resin and which can diffuse light passing through the light diffuser plate, when contained and dispersed in the base layer. Examples of the light diffuser particles include inorganic particles such as glass particles, glass fibers, silica particles, aluminum hydroxide particles, calcium carbonate particles, barium sulfate particles, titanium oxide particles, talc, etc.; and organic particles such as styrenic polymer particles, acrylic polymer particles, siloxane-based polymer particles, etc.

The resin composition forming the base layer (8) may contain a resin other than the styrenic resins, in addition to additives such as an UV absorber, a thermal stabilizer, an antioxidant, a weathering agent, a light stabilizer, a fluorescent brightener, a processing stabilizer, a nucleating agent, etc., to an extent that the effect of the present invention is not impaired.

Similarly, the surface layer (9) may contain a resin other than the polycarbonate resins, in addition to additives such as an UV absorber, a thermal stabilizer, an antioxidant, a weathering agent, a light stabilizer, a fluorescent brightener, a processing stabilizer, a nucleating agent, etc., to an extent that the effect of the present invention is not impaired.

The thickness (S) of the base layer (8) is usually from 500 to 2,990 μm. When this thickness is 500 μm or more, a sufficient mechanical strength can be ensured. When this thickness is 2,990 μm or less, an increase in cost can be suppressed. Preferably, the thickness (S) of the base layer (8) is from 700 to 2,980 μm.

The thickness (T) of the surface layer (9) is usually from 10 to 300 μm. When this thickness is 10 μm or more, a sufficient impact resistance can be obtained. When this thickness is 300 μm or less, an increase in cost can be suppressed. Preferably, the thickness (T) of the surface layer (9) is from 20 to 200 μm.

In the light diffuser plate (3) of the present invention, the ratio of the thickness of the base layer to the thickness of the surface layer (S/T) is preferably set at from 5 to 100. When this ratio is 5 or more, an increase in cost can be suppressed. When this ratio is 100 or less, a sufficient impact resistance can be ensured. More preferably, the ratio of the thickness of the base layer to the thickness of the surface layer (S/T) is set at from 8 to 80. In this regard, the thickness of the light diffuser plate (3) is usually set at from 1 to 3 mm.

In the above-described embodiment, the surface layers (9), (9) are laminated on and integrated into both surfaces of the base layer (8). However, the present invention is not limited to this embodiment: the surface layer (9) may be laminated on and integrated into one surface of the base layer (8). To sufficiently prevent warping of the plate, the lamination and integration of the surface layers (9), (9) onto both surfaces of the base layer (8) as in the above-described embodiment is preferably employed.

The light diffuser plate (3) of the present invention may be fabricated, for example, by any of the co-extrusion molding method, the laminating method, the heat bonding method, the solvent bonding method, the polymerization bonding method, the cast polymerization method, the surface coating method and the like.

When the light diffuser plate (3) is fabricated by the co-extrusion method, the resin composition for forming the base layer (8) and the resin or the resin composition for forming the surface layer (9) are co-extruded at once. For example, the resin composition for forming the base layer (8) and the resin or the resin composition for forming the surface layer (9) are heated in separate extruders, respectively, and are extruded through a die for co-extrusion, while being melt-kneaded, so as to laminate and integrate both the layers onto each other. As the extruders, single-screw extruders, twin-screw extruders, etc. can be used. As the die for co-extrusion, for example, a feed block die, a multi-manifold die, etc. can be used. The respective resin compositions are extruded through the die for lamination and integration of the respective layers, and the integrated layer is usually held between cooling rolls to be cooled. Thus, the light diffuser plate (3) is obtained.

When the light diffuser plate (3) is fabricated by the lamination method, the resin or the resin composition for forming the surface layer(s), heated to be in a molten state, is laminated on one or both of the surfaces of the previously formed base layer (8). After the lamination, the resin or the resin composition is cooled and solidified so that the resulting surface layer(s) are laminated on and integrated into one or both of the surfaces of the base layer (8). Thus, the intended light diffuser plate (3) is obtained.

When the light diffuser plate (3) is fabricated by the thermal bonding method, for example, the film-like formed surface layer (9), while being heated, is pressed onto the surface of the previously formed base layer (8). By heating the surface layer (9) to a temperature higher than the softening point of the resin or resin composition of the surface layer (9) and pressing it, the surface layer (9) and the base layer (8) are laminated on and integrated into each other by their thermal fusion. Thus, the intended light diffuser plate (3) is obtained.

When the light diffuser plate is fabricated by the solvent bonding method, the formed base layer (8) and the formed surface layer (9) are prepared; a solvent capable of dissolving one or both of these layers is applied to the bonding surface(s) of one or both of the layers; and the layers are laminated on each other. After the lamination, the solvent is vaporized to thereby laminate and integrate the surface layer (9) and the base layer (8) onto each other. Thus, the light diffuser plate (3) is obtained.

When the light diffuser plate (3) is fabricated by the polymerization bonding method, the formed base layer (8) and the formed surface layer (9) are prepared; a polymerizable adhesive is applied to the bonding surface(s) of one or both of the layers; and the layers are laminated on each other. After the lamination, the polymerizable adhesive is polymerized. The polymerizable adhesive contains a polymerizable monomer and a polymerization initiator. The polymerization initiator may be a thermopolymerization initiator which initiates the polymerization of the monomer by heating or a photopolymerization initiator which initiates the polymerization of the monomer by exposure to light. The polymerizable adhesive is polymerized by heating or exposing to light, according to the kind of the polymerization initiator to be used. The surface layer (9) and the base layer (8) are thus laminated on and integrated into each other to obtain the light diffuser plate (3).

The above-described fabrication methods are illustrative only, and the light diffuser plate (3) of the present invention is not limited to one fabricated by such a method.

The size of the light diffuser plate (3) of the present invention is not limited, and may be appropriately selected according to the size of an intended surface light source (1) or an intended liquid crystal display (30). Above all, the light diffuser plate designed for such an apparatus of Model 20 (30 cm in length×40 cm in width) or more is particularly suitable.

The light diffuser plate (3), the surface light source (1) and the liquid crystal display (30) of the present invention are not limited to those of the above-described embodiments, and any alternation or modification in their designs may be allowed within the scope of the present invention, in so far as they do not depart from the spirit of the present invention.

### EXAMPLES

Next, specific examples of the present invention will be described, but should not be construed as limiting the scope of the present invention in any way.

### <Raw Materials>

### (Preparation of Master Batch of Light Diffuser Particles)

The following components were dry-blended, and the resulting composition was supplied to a twin-screw extruder and was strand-like extruded at 250° C., and the resulting strand of the composition was cut into pellets as a master batch of light diffuser particles:

77.5 parts by mass of a styrene-metacrylic acid copolymer (“T080” manufactured by TOYO STYRENE CO., LTD.),

3.0 parts by mass of siloxane-based polymer particles (light diffuser particles) (“Trefil DY33-719” with a volume-average particle size of 2 μm, manufactured by Dow Corning Toray),

18.0 parts by mass of acrylic polymer particles (light diffuser particles) (“MBX2H” with an average particle diameter of 3 μm, manufactured by Sekisui Plastics Co., Ltd.),

0.75 parts by mass of Sumilizer GP (a stabilizer manufactured by Sumitomo Chemical Company, Limited),

0.75 parts by mass of Sumisorb 200 (a benzotriazole-based UV absorber manufactured by Sumitomo Chemical Company, Limited), and

0.03 parts by mass of White Flow PSNconc (an oxazole-based fluorescent brightener manufactured by SUMIKA COLOR CO., LTD.).

### Example 1

Styrene-methacrylic acid copolymer pellets (“T080” manufactured by TOYO STYRENE CO., LTD.) (90 parts by mass) and the above-described master batch (pellets of light diffuser particles) (10 parts by mass) were dry-blended, and the resulting composition was supplied to a first extruder with a screw diameter of 40 mm and was melt-kneaded therein at 250° C. and was then supplied to a feed block.

On the other hand, a polycarbonate resin (“CALIBRE PC200-30” manufactured by SUMITOMO DOW LIMITED) (90.8 parts by mass), acrylic polymer particles (crosslinked polymer particles) (“SUMIPEX XC1A” with a volume-average particle size of about 25 μm, manufactured by Sumitomo Chemical Company, Limited) (8.0 parts by mass), Adekastab LA31 (a benzotriazole-based UV absorber manufactured by ADEKA) (1.0 part by mass) and Sumilizer GP (a processing stabilizer manufactured by Sumitomo Chemical Company, Limited) (0.2 parts by mass) were dry-blended, and the resulting composition was supplied to a second extruder with a screw diameter of 20 mm and was melt-kneaded therein at 250° C. and was then supplied to the feed block.

The resin composition supplied to the feed block from the first extruder and the resin composition supplied to the feed block from the second extruder were co-extruded at a temperature of from 245 to 250° C. so as to form the base layer (8) and the surface layers (9), (9), respectively. Thus, a light diffuser plate (3) consisting of a three-layered lamination with a thickness of 2.00 mm (the thickness of the base layer: 1.90 mm, and the thickness of the surface layers: 0.05 mm×2) was fabricated.

### Example 2

A light diffuser plate was fabricated in the same manner as in Example 1, except that the thickness of the base layer was changed to 1.80 mm, and the thickness of the surface layer, to 100 μm.

### Example 3

A light diffuser plate was fabricated in the same manner as in Example 1, except that the thickness of the base layer was changed to 1.85 mm, and the thickness of the surface layer, to 75 μm.

### Example 4

A light diffuser plate was fabricated in the same manner as in Example 1, except that the thickness of the base layer was changed to 1.94 mm, and the thickness of the surface layer, to 30 μm.

### Comparative Example 1

Styrene-methacrylic acid copolymer pellets (“T080” manufactured by TOYO STYRENE CO., LTD.) (90 parts by mass) and the above-described light diffuser particle master batch (pellets) (10 parts by mass) were dry-blended, and the resulting composition was supplied to a first extruder with a screw diameter of 40 mm and was melt-kneaded at 250° C., followed by extrusion from a T die at a temperature of from 245 to 250° C. Thus, a single-layer light diffuser plate with a thickness of 2.00 mm was fabricated.

### Comparative Example 2

A light diffuser plate was fabricated in the same manner as in Example 1, except that the resin composition (for the surface layer) supplied to the second extruder was changed to a resin composition which comprised a styrene-methyl methacrylate copolymer resin (“MS200NT” manufactured by Nippon Steel Chemical Co., Ltd.) (90.55 parts by mass), acrylic polymer particles (crosslinked polymer particles) (“SUMIPEX XC1A” with a volume-average particle size of about 25 μm, manufactured by Sumitomo Chemical Company, Limited) (8.0 parts by mass), Adekastab LA31 (a benzotriazole-based UV absorber manufactured by ADEKA) (1.0 part by mass), Sumilizer GP (a processing stabilizer manufactured by Sumitomo Chemical Company, Limited) (0.2 parts by mass), and Monogly D (a molding processing agent manufactured by NOF Corporation) (0.25 parts by mass).

### Comparative Example 3

A light diffuser plate was fabricated in the same manner as in Example 1, except that the resin composition (for the surface layer) supplied to the second extruder was changed to a resin composition which comprised a styrene-methyl methacrylate copolymer resin (“MS200NT” manufactured by Nippon Steel Chemical Co., Ltd.) (75.8 parts by mass), acrylic polymer particles (crosslinked polymer particles) (“SUMIPEX XC1A” with a volume-average particle size of about 25 μm, manufactured by Sumitomo Chemical Company, Limited) (23.0 parts by mass), Adekastab LA31 (a benzotriazole-based UV absorber manufactured by ADEKA) (1.0 part by mass), and Sumilizer GP (a processing stabilizer manufactured by Sumitomo Chemical Company, Limited) (0.2 parts by mass).

### Comparative Example 4

A light diffuser plate was fabricated in the same manner as in Example 1, except that the resin composition (for the surface layer) supplied to the second extruder was changed to a resin composition which comprised a methyl methacrylate-butadiene-styrene copolymer resin (a MBS resin, “HW” manufactured by Sumitomo Chemical Company, Limited) (90.55 parts by mass), acrylic polymer particles (crosslinked polymer particles) (“SUMIPEX XC1A” with a volume-average particle size of about 25 μm, manufactured by Sumitomo Chemical Company, Limited) (8.0 parts by mass), Adekastab LA31 (a benzotriazole-based UV absorber manufactured by ADEKA) (1.0 part by mass), Sumilizer GP (a processing stabilizer manufactured by Sumitomo Chemical Company, Limited) (0.2 parts by mass), and Monogly D (a molding processing agent manufactured by NOF Corporation) (0.25 parts by mass).

TABLE 1
(Amounts of Components: part by mass in unit)

| | | Ex. 1 | Ex. 2 | Ex. 3 | Ex. 4 |
|---|---|---|---|---|---|
| Composition | Polycarbonate | 90.8 | 90.8 | 90.8 | 90.8 |
| of surface | resin | | | | |
| layer | Styrene-methyl | — | — | — | — |
| | methacrylate | | | | |
| | copolymer | | | | |
| | MBS resin | — | — | — | — |
| | XC-1A (acrylic | 8.0 | 8.0 | 8.0 | 8.0 |
| | polymer | | | | |
| | particles) | | | | |
| | LA31 (UV | 1.0 | 1.0 | 1.0 | 1.0 |
| | absorber) | | | | |
| | Sumilizer GP | 0.2 | 0.2 | 0.2 | 0.2 |
| | (processing | | | | |
| | stabilizer) | | | | |
| | Monogly D | — | — | — | — |
| | (molding | | | | |
| | processing | | | | |
| | agent) | | | | |
| Composition | Styrene- | 90 | 90 | 90 | 90 |
| of base | methacrylic | | | | |
| layer | acid copolymer | | | | |
| | Light diffuser | 10 | 10 | 10 | 10 |
| | particle | | | | |
| | master batch | | | | |

| | | | | |
|---|---|---|---|---|
| Thickness S of base layer (mm) | 1.90 | 1.80 | 1.85 | 1.94 |
| Thickness T of surface layer | 50 | 100 | 75 | 30 |
| (μm) (only one side) | | | | |
| Thickness of light diffuser | 2.00 | 2.00 | 2.00 | 2.00 |
| plate (mm) | | | | |
| Total light transmittance (%) | 55.7 | 56.3 | 56.0 | 56.7 |
| Diffused light transmittance (%) | 55.2 | 55.7 | 55.3 | 56.0 |
| Haze (%) | 99.1 | 98.9 | 98.8 | 98.8 |
| Evaluation of impact resistance | 0 | 0 | 0 | 0 |
| (number of damaged plates out | | | | |
| of 10 plates) | | | | |
| Evaluation of coloring of light | None | None | None | None |
| diffuser plate | | | | |

| | | C. Ex. 1 | C. Ex. 2 | C. Ex. 3 | C. Ex. 4 |
|---|---|---|---|---|---|
| Composition | Polycarbonate | No | — | — | — |
| of surface | resin | surface | | | |
| layer | Styrene-methyl | layer | 90.55 | 75.8 | — |
| | methacrylate | | | | |
| | copolymer | | | | |
| | MBS resin | | — | — | 90.55 |
| | XC-1A (acrylic | | 8.0 | 23.0 | 8.0 |
| | polymer | | | | |
| | particles) | | | | |
| | LA31 (UV | | 1.0 | 1.0 | 1.0 |
| | absorber) | | | | |
| | Sumilizer GP | | 0.2 | 0.2 | 0.2 |
| | (processing | | | | |
| | stabilizer) | | | | |
| | Monogly D | | 0.25 | — | 0.25 |
| | (molding | | | | |
| | processing | | | | |
| | agent) | | | | |
| Composition | Styrene- | 90 | 90 | 90 | 90 |
| of base | methacrylic | | | | |
| layer | acid copolymer | | | | |
| | Light diffuser | 10 | 10 | 10 | 10 |
| | particle | | | | |
| | master batch | | | | |

| | | | | |
|---|---|---|---|---|
| Thickness S of base layer (mm) | 2.00 | 1.90 | 1.90 | 1.90 |
| Thickness T of surface layer | | 50 | 50 | 50 |
| (μm) (only one side) | | | | |
| Thickness of light diffuser | 2.00 | 2.00 | 2.00 | 2.00 |
| plate (mm) | | | | |
| Total light transmittance (%) | 55.9 | 55.5 | 55.5 | 55.2 |
| Diffused light transmittance (%) | 55.3 | 54.9 | 54.9 | 54.6 |
| Haze (%) | 98.9 | 98.9 | 98.9 | 98.9 |
| Evaluation of impact resistance | 6 | 2 | 5 | 1 |
| (number of damaged plates out | | | | |
| of 10 plates) | | | | |
| Evaluation of coloring of light | None | None | None | Colored |
| diffuser plate | | | | |

The respective light diffuser plates fabricated as above were evaluated by the following evaluating methods. The evaluation results are shown in Table 1.

### <Measurement of Total Light Transmittance>

The total light transmittances (%) of the light diffuser plates were measured according to JIS K7361-1997.

### <Measurement of Diffused Light Transmittance>

The diffused light transmittances (%) of the light diffuser plates were measured according to JIS K7136-2000.

### <Measurement of Haze>

The hazes (%) of the light diffuser plates were measured according to JIS K7136-2000.

### <Evaluation of Impact Resistance>

Each of the light diffuser plates was cut into rectangular test pieces of 5 cm×5 cm. This test piece was left to stand alone at 23° C. under an atmosphere of humidity of 50% for 24 hours. After that, a drop impact test was conducted on the test piece disposed horizontally, by dropping a weight (1.4 inch) with a load of 150 g from a position with a height of 20 cm, under this atmosphere, using a Dupont drop impact tester (“Y.S.S. Tester” manufactured by YASUDA SEIKI SEISAKUSHO LTD.). Whether or not the test piece was crazed or cracked by an impact from the weight was examined. Ten test pieces were prepared from each of the diffuser plates, and the above-described drop impact tests were conducted on these 10 test pieces to find how many test pieces were damaged, that is, crazed or cracked, out of the 10 test pieces, so as to evaluate the impact resistance of the light diffuser plate.

### <Evaluation of Coloring of Light Diffuser Plate>

Each of the light diffuser plates was visually observed in front, against a white wall, so as to find whether or not the light diffuser plate was colored. A light diffuser plate of which yellowish coloring or the like was relatively slight was evaluated as “not colored”, and a light diffuser plate which was a little colored yellowish was evaluated as “colored”.

As is apparent from the results of Table, the light diffuser plates of Examples 1 to 4 of the present invention were slight in yellowish coloring thereof and had sufficient impact resistances.

In contrast, the light diffuser plates of Comparative Examples 1 to 4 had not sufficient impact resistances. The light diffuser plate of Comparative Example 4 was a little colored yellowish.

While any of the light diffuser plates of the present invention can be suitably used as a light diffuser plate for a surface light source, the application thereof is not limited to such. While any of the surface light sources of the present invention can be suitably used as a backlight for a liquid crystal display, the application thereof is not limited to such.

What is claimed is:

1. A light diffuser plate, characterized in that a surface layer containing a polycarbonate resin is laminated on at least one surface of a base layer containing a styrenic resin and light diffuser particles.

2. The light diffuser plate of claim 1, wherein said styrenic resin is a styrenic monomer-methacrylic acid copolymer resin.

3. The light diffuser plate of claim 1, wherein a ratio of the thickness of said base layer to the thickness of said surface layer is from 5 to 100.

4. A surface light source comprising a light diffuser plate defined in any one of claims 1 to 3, and a plurality of light sources disposed on the rear side of said light diffuser plate.

5. A liquid crystal display comprising a light diffuser plate defined in any one of claims 1 to 3, a plurality of light sources disposed on the rear side of said light diffuser plate, and a liquid crystal panel disposed on the front side of said light diffuser plate.
